(19) United States
(12) Patent Application Publication
(10) Pub. No.: US 2007/0003213 A1
(43) Pub. Date: Jan. 4, 2007

(54) Method and apparatus for managing time information of broadcast streams

(75) Inventors: Jung-min Kang, Seoul (KR); Soo-kang Bae, Seongnam-si (KR); Jin-yong Ahn, Suwon-si (KR); Du-il Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/476,609

(22) Filed: Jun. 29, 2006

Related U.S. Application Data
(60) Provisional application No. 60/694,999, filed on Jun. 30, 2005.

(30) Foreign Application Priority Data
Jul. 13, 2005 (KR) 10-2005-0063287

(51) Int. Cl. H04N 5/91

(52) U.S. Cl. 386/65

(57) ABSTRACT

A method and apparatus for managing time information of broadcast streams are provided. The method includes: extracting time information from each of the respective input broadcast streams; setting the time information, extracted from an input broadcast stream that has been set in advance as a reference broadcast stream, as reference time information; and calculating time information for each of the respective input broadcast streams by comparing the time information of each of the respective input broadcast streams with the reference time information. Accordingly, it is possible to minimize various errors caused by errors among time information extracted from the respective broadcast streams when executing a time-dependent application program, such as a time recording program.

### CROSS-REFERENCE TO RELATED PATENT APPLICATION

This application claims priority from Korean Patent Application No. 10-2005-0063287, filed on Jul. 13, 2005 in the Korean Intellectual Property Office, and U.S. Provisional Application No. 60/694,999, filed on Jun. 30, 2005, in the U.S. Patent and Trademark Office, the disclosures of which are incorporated herein in their entirety by reference.

### BACKGROUND OF THE INVENTION

1. Field of the Invention

Methods and apparatuses consistent with the present invention relate to managing time information of broadcast streams, and more particularly, to managing time information of broadcast streams in which time information extracted from a plurality of broadcast streams input to a digital broadcast reception device is managed by setting time information extracted from a broadcast stream input via a certain channel as reference time information and comparing time information extracted from other broadcast streams with the reference time information.

2. Description of the Related Art

Digital broadcasting, for example, high definition television (HDTV) broadcasting or digital multimedia broadcasting (DMB), provides a variety of advantages, such as high audio and video qualities and mobility, that cannot be provided by conventional analog broadcasting. In accordance with the commencement of digital broadcasting, various digital broadcasting technologies have been developed and commercialized.

Digital broadcast reception devices, which are classified as being portable or non-portable, include their own clocks called real time clocks (RTCs). Therefore, digital broadcast reception devices perform various time-dependent operations with reference to time information provided by their respective RTCs.

FIG. 1 is a block diagram illustrating the transmitting and receiving of a digital broadcast by a related art digital broadcast transmission/reception device 100. Referring to FIG. 1, the digital broadcast transmission/reception device 100 includes a digital broadcast transmission unit 120 and a digital broadcast reception unit 140.

The digital broadcast transmission unit 120 multiplexes video data 122, audio data 124, and other data 126, such as channel number information and running time information, using a multiplexer 128 included therein, thereby generating a transport stream (TS).

The digital broadcast transmission unit 120 transmits the TS to the digital broadcast reception unit 140 via a channel 160. The TS is a bitstream into which a plurality of packets comprising video bitstreams and audio bit streams are multiplexed. In other words, the digital broadcast transmission unit 120 can multiplex a plurality of broadcast programs into a single bit stream.

The digital broadcast reception unit 140 demultiplexes the TS transmitted by the digital broadcast transmission unit 140 using a demultiplexer 148 included therein, thereby extracting video data 142, audio data 144, and other data 146. Thereafter, the digital broadcast reception unit 140 decodes the video data 142, the audio data 144, and the other data 146 so that they can be displayed.

The other data 126 or 146 may include various information regarding predetermined digital broadcast standards, such as broadcasting time information.

In general, dozens through several hundreds of broadcast streams are simultaneously input to a broadcast reception device. Therefore, it is necessary to determine how reference time information for the broadcast reception device is to be set, based on the input broadcast streams.

In addition, if more than one time information is set in a digital broadcast transmission device, a plurality of time information extracted from respective broadcast streams transmitted to a digital broadcast reception device by the digital broadcast transmission device may not match one another. In this case, the digital broadcast reception device needs to determine how to handle and manage reference time information and other time information. For example, in a case where a user sets a time recording function for a predetermined broadcast stream so that the predetermined broadcast stream can be automatically recorded at a predetermined moment of time, the predetermined broadcast stream may not be able to be properly recorded if reference time information set in a digital broadcast transmission device transmitting the predetermined broadcast program is different from reference time information set in a digital broadcast reception device.

### SUMMARY OF THE INVENTION

The present invention provides a method and apparatus for managing time information of broadcast streams in which time information extracted from a plurality of broadcast streams input to a digital broadcast reception device is managed by setting time information extracted from a broadcast stream input via a certain channel as reference time information and comparing time information extracted from other broadcast streams with the reference time information.

According to an aspect of the present invention, there is provided a method of managing time information of a plurality of broadcast streams input to a broadcast reception device. The method comprises: extracting a plurality of time information from the respective input broadcast streams; setting the time information extracted from the input broadcast stream that has been set in advance as a reference broadcast stream as reference time information; and calculating a plurality of error time information for the respective input broadcast streams by comparing the plurality of time information with the reference time information.

According to another aspect of the present invention, there is provided an apparatus for managing time information of a plurality of broadcast streams input to a broadcast reception device. The apparatus comprises: a time information extraction unit which extracts a plurality of time information from the respective input broadcast streams; a reference time information setting unit which sets the time information extracted from one of the input broadcast streams that has been set in advance as a reference broadcast stream as reference time information; and a time error calculation unit which calculates a plurality of error time information for the respective input broadcast streams by comparing the plurality of time information with the reference time information.

According to another aspect of the present invention, there is provided a computer-readable recording medium storing a computer program for executing the method of managing time information of a plurality of broadcast streams input to a broadcast reception device.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating the transmitting and receiving of a digital broadcast program by a related art digital broadcast transmission/reception device;

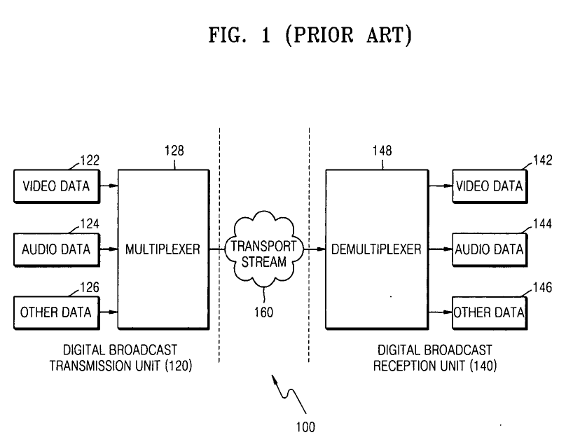

FIG. 2 is a flowchart illustrating a method of managing time information of broadcast streams according to an exemplary embodiment of the present invention;

FIG. 3 is a flowchart illustrating a method of updating time information in a case where a new broadcast stream is input according to an exemplary embodiment of the present invention;

FIG. 4 is a flowchart illustrating a method of time-recording broadcast streams with reference to time information of the broadcast streams according to an exemplary embodiment of the present invention; and

FIG. 5 is a block diagram of an apparatus for managing time information of broadcast streams according to an exemplary embodiment of the present invention.

### DETAILED DESCRIPTION EXEMPLARY EMBODIMENTS OF THE INVENTION

The present invention will now be described more fully with reference to the accompanying drawings in which exemplary embodiments of the invention are shown.

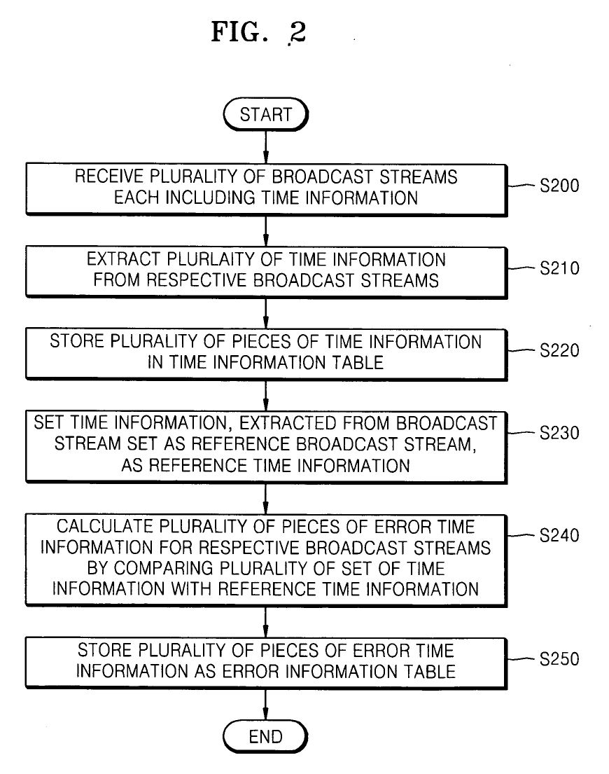

FIG. 2 is a flowchart illustrating a method of managing time information of broadcast streams according to an exemplary embodiment of the present invention. Referring to FIG. 2, in operation S200, a broadcast reception device, e.g., a digital broadcast reception device, receives a plurality of broadcast streams each including time information. Particularly, the broadcast reception device may receive a plurality of broadcast streams transmitted by a broadcast transmission device via wired channels or wireless channels. In detail, the broadcast reception device may comprise a digital broadcast reception device, and the broadcast transmission device may comprise a digital broadcast transmission device. The broadcast streams transmitted by the broadcast transmission device are one type of transport streams transmitted according to predetermined broadcast standards.

After operation S200, it may be determined whether the broadcast streams received in operation S200 include time information because broadcast streams may not include time information according to predetermined digital broadcast standards.

In operation S210, a plurality of time information is extracted from the respective broadcast streams. The plurality of time information is contained in predetermined portions of the respective broadcast streams. The broadcast reception device extracts time information from a broadcast stream in a predetermined approach that is compatible with a set of broadcast standards used by the broadcast transmission device to generate the broadcast streams.

In operation S220, a time information table is generated using the plurality of time information extracted in operation S210 and then is stored. Operation S220 is optional. Table 1 is an example of the time information table.

TABLE 1

| | Channel A | | | |
|---|---|---|---|---|
| | (Reference Time | | | |
| | Information) | Channel B | Channel C | . . . |
| Time Information | 10:00:30 | 10:00:15 | 10:00:45 | . . . |

In operation S230, one of the plurality of time information is set as reference time information. Referring to Table 1, if a broadcast stream received via channel A is determined as being a reference broadcast stream with the aid of a user interface, time information 10:00:30 may be set as reference time information. A real time clock (RTC) of the broadcast reception device may be set with reference to the reference time information set in operation S230.

In operation S240, a plurality of error time information for the respective broadcast streams is calculated by comparing the respective time information with the reference time information. For example, if the time information of channel A is set as the reference time information, error time information for channel B may be set to −15 seconds, and error time information for channel C may be set to +15 seconds. In operation S250, an error time information table is generated using the error time information extracted in operation S240 and then is stored.

Table 2 is an example of the error time information table.

TABLE 2

| | Channel A | | | |
|---|---|---|---|---|
| | (Reference Time | | | |
| | Information) | Channel B | Channel C | . . . |
| Error Time Information | 0 sec | −15 sec | −15 sec | . . . |

The time information table and the error time information may be integrated into a single table as indicated in Table 3.

TABLE 3

| | Channel A | | | |
|---|---|---|---|---|
| | (Reference Time | | | |
| | Information) | Channel B | Channel C | . . . |
| Time Information | 10:00:30 | 10:00:15 | 10:00:45 | . . . |
| Error Time Information | 0 sec | −15 sec | +15 sec | . . . |

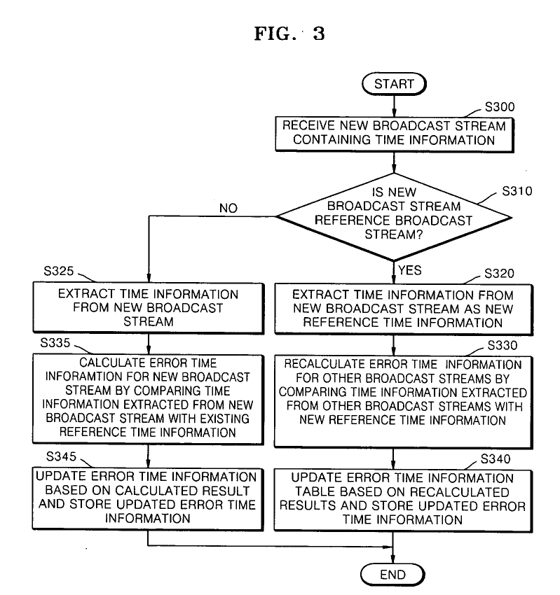

FIG. 3 is a flowchart illustrating a method of updating time information if a new broadcast stream is input according to an exemplary embodiment of the present invention. Referring to FIG. 3, in operation S300, a new broadcast stream including time information is received.

In operation S310, it is determined whether the new broadcast stream is a reference broadcast stream. In operation S320, if the new broadcast stream is determined to be the reference broadcast stream, time information is extracted from the new broadcast stream as new reference time information. In operation S325, if the new broadcast stream is determined not to be the reference broadcast stream, time information is extracted from the new broadcast stream but is not set as the new reference time information.

In operation S330, a plurality of error time information is calculated by comparing a plurality of time information extracted from the respective broadcast streams with the new reference time information set in operation S320. For example, referring to Table 1, if the new reference time information is set to 10:00:32, error time information for channel B may be set to −17 seconds, and error time information for channel C may be set to +13 seconds, as shown below in Table 4 and Table 5.

In operation S340, an error time information table is updated based on the plurality of error time information obtained in operation S330 and is then stored. Tables 4 and 5 are examples of the updated error time information obtained using the error time information obtained in operation S330.

TABLE 4

| | Channel A | | | |
|---|---|---|---|---|
| | (Reference Time | | | |
| | Information) | Channel B | Channel C | . . . |
| Error Time Information | 0 sec | −17 sec | +13 sec | . . . |

TABLE 5

| | Channel A | | | |
|---|---|---|---|---|
| | (Reference Time | | | |
| | Information) | Channel B | Channel C | . . . |
| Time Information | 10:00:32 | 10:00:15 | 10:00:45 | . . . |
| Error Time Information | 0 sec | −17 sec | +13 sec | . . . |

In operation S335, error time information for the new broadcast stream is calculated by comparing existing reference time information with the time information extracted from the new broadcast stream. For example, if the existing reference time information is 10:00:30 and the time information extracted from the new broadcast stream is identical to the time information for channel B as indicated in Table 7, the error time information for the new broadcast stream may be set to −12 seconds.

In operation S345, the error time information table is updated based on the error time information obtained in operation S335 and then is stored. Tables 6 and 7 are examples of the updated error time information obtained using the error time information obtained in operation S335.

TABLE 6

| | Channel A | | | |
|---|---|---|---|---|
| | (Reference Time | | | |
| | Information) | Channel B | Channel C | . . . |
| Error Time Information | 0 sec | −12 sec | +13 sec | . . . |

TABLE 7

| | Channel A | | | |
|---|---|---|---|---|
| | (Reference Time | | | |
| | Information) | Channel B | Channel C | . . . |
| Time Information | 10:00:30 | 10:00:18 | 10:00:45 | . . . |
| Error Time Information | 0 sec | −12 sec | +13 sec | . . . |

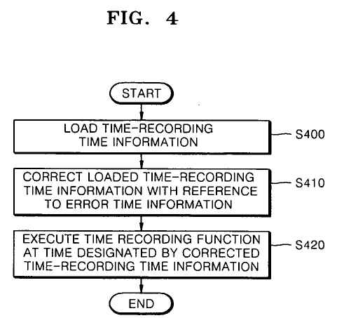

FIG. 4 is a flowchart illustrating a method of time-recording broadcast streams with reference to time information of the broadcast streams according to an exemplary embodiment of the present invention. Referring to FIG. 4, in operation S400, time-recording time information, regarding a broadcast stream of a predetermined channel input to a broadcast reception device (e.g., a digital broadcast reception device) for which a time-recording function has been set by a user, is loaded. Particularly, the user may have set the time-recording function for the broadcast stream of the predetermined channel by choosing the predetermined broadcasting time and the predetermined channel using a time recording function provided by the broadcast reception device.

In operation S410, the loaded time-recording time information is corrected with reference to the loaded error time information. If there is no error time information regarding the broadcast stream of the predetermined channel, the correction of the loaded time-recording time information becomes unnecessary.

In operation S420, the time recording function is executed so that the broadcast stream of the predetermined channel can be automatically recorded at a moment of time designated by the corrected time-recording time information. In particular, the corrected time-recording time information is in synchronization with reference time information of the broadcast reception device, and thus, it is possible to time-record the broadcast program of the predetermined channel at the exact moment of time designated by the corrected time-recording time information.

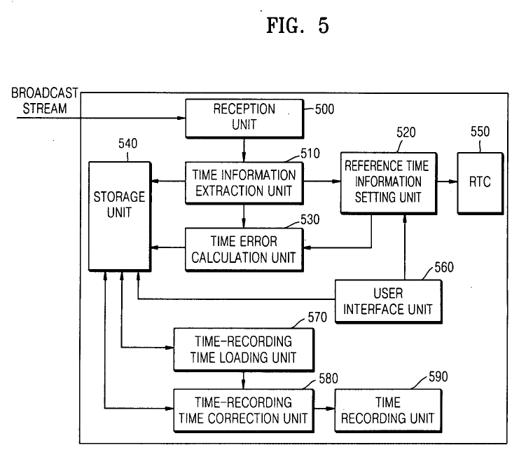

FIG. 5 is a block diagram of an apparatus for managing time information of digital broadcast streams according to an exemplary embodiment of the present invention. Referring to FIG. 5, the apparatus includes a reception unit 500, a time information extraction unit 510, a reference time information setting unit 520, a time error calculation unit 530, a storage unit 540, an RTC 550, a user interface unit 560, a time-recording time loading unit 570, a time-recording time correction unit 580, and a time-recording unit 590. Units other than those illustrated in FIG. 5 may also be included in the apparatus for the operation of the apparatus but will not be described here in order not to make the scope of the present invention unclear.

The reception unit 500 receives a plurality of broadcast streams each including time information via one or more channels. The channels may be wireless channels or wired channels. The broadcast streams received by the reception unit 500 are one type of transport streams transmitted according to predetermined broadcast standards.

The time information extraction unit 510 extracts a plurality of time information from the respective broadcast streams received by the reception unit 500. The plurality of time information is contained in predetermined portions of the respective broadcast streams. The time information extraction unit 510 extracts the plurality of time information from the respective broadcast streams received by the reception unit 500 in a predetermined approach that is compatible with a set of broadcast standards used by a broadcast transmission device to insert the plurality of time information into the respective broadcast streams. The time information extraction unit 510 outputs the plurality of time information to the storage unit 540, the time error calculation unit 530, and the reference time information setting unit 520.

The reference time information setting unit 520 sets the time information, extracted from the received broadcast stream that has been set as a reference broadcast stream, as reference time information.

The received broadcast stream that has been set as the reference broadcast stream is a broadcast stream received by the reception unit 500 via a channel chosen by a user with the aid of the user interface unit 560 or via a channel set in the broadcast reception device in advance.

The reference time information setting unit 520 sets the RTC 550 with reference to the reference time information.

The RTC 550 may be included in the broadcast reception device regardless of whether the broadcast reception device is portable or non-portable. Therefore, the broadcast reception device can perform various time-dependent operations with reference to time information provided by the RTC 550.

The time error calculation unit 530 receives the plurality of time information from the time information extraction unit 510 and receives the reference time information from the reference time information setting unit 520. Thereafter, the time error calculation unit 530 calculates a plurality of error time information for the respective broadcast streams by comparing the respective plurality of time information with the reference time information.

The storage unit 540 stores the plurality of time information received from the time information extraction unit 510 and the plurality of error time information received from the time error calculation unit 530 as, for example, a time information table and an error time information table which have already been described with reference to FIGS. 2-4.

The user interface unit 560 provides an input/output interface which is connected to a control unit (not shown) and receives a command from the user for controlling the broadcast reception device. The user interface unit 560 enables the user to set one of a plurality of broadcast streams input to the broadcast reception device as a reference broadcast stream with the aid of the input/output interface. Time information extracted from the broadcast stream set as the reference broadcast stream is determined as reference time information. The user interface unit 560 chooses a broadcast stream broadcast at a certain moment of time via a predetermined channel, sets a time-recording function for the chosen broadcast stream so that the chosen broadcast stream can be automatically recorded when broadcast, and stores information regarding the chosen broadcast stream in the storage unit 540.

The user interface unit 560 may be comprised of an infrared ray (IR) receiver that follows a command input via a keypad or an IR remote controller. The IR remote controller may be a wireless mouse, such as an Air mouse, or a typical remote controller.

The time-recording time loading unit 570 loads time-recording time information regarding the broadcast program for which the time recording function has been set from the storage unit 540.

The user may set the time recording function by choosing a predetermined broadcasting time and a predetermined channel using a time-recording program provided by the broadcast reception device. The time-recording time loading unit 570 outputs the loaded time-recording time information to the time-recording time correction unit 580 if an error between the loaded time-recording time information and time information provided by the RTC 550 is within a predefined range.

The time-recording time correction unit 580 receives the time-recording time information output by the time-recording time loading unit 570, loads error time information regarding the broadcast stream for which the time recording function has been set from the storage unit 540, and corrects the received time-recording time information with reference to the loaded error time information. If no error time information regarding the broadcast stream for which the time recording function has been set exists in the storage unit 540, the time-recording time correction unit 580 does not need to correct the received time-recording time information.

The time recording unit 590 executes the time recording function so that the broadcast stream for which the time recording function has been set can be automatically recorded at a moment of time when the time-recording time information provided by the time-recording time correction unit 580 matches the time information provided by the RTC 550.

The time-recording time information provided by the time-recording time correction unit 580 is already in synchronization with the reference time information set in the broadcast reception device. Thus, it is possible to accurately time-record the broadcast stream.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that a computer-readable code is written thereto and executed therefrom in a decentralized manner. Functional programs, code, and code segments needed for realizing the present invention can be easily constructed by one of ordinary skill in the art.

In the present invention, one of a plurality of broadcast streams input to a broadcast reception device (particularly, a digital broadcast reception device) is set as a reference broadcast stream, time information extracted from the input broadcast stream set as the reference broadcast stream is set as reference time information, and errors between the reference time information and a plurality of time information extracted from the other broadcast streams are managed. Therefore, it is possible to minimize various errors caused by errors among a plurality of time information extracted from the respective broadcast streams when executing a time-dependent application program, such as a time recording program.

In addition, it is possible to minimize time errors between the reference time information and other time information, even when the broadcast reception device receives new transport streams with each including time information, by appropriately updating the reference time information and errors between the reference time information and the other time information.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of managing time information of a plurality of broadcast streams input to a broadcast reception device comprising:
extracting time information from each of the respective input broadcast streams;
setting the time information, extracted from an input broadcast stream among the plurality of input broadcast streams that has been set in advance as a reference broadcast stream, as reference time information; and
calculating error time information for each of the respective input broadcast streams by comparing the time information of each of the respective input broadcast streams with the reference time information.

2. The method of claim 1 further comprising generating a time information table using the time information of each of the respective input broadcast streams and storing the generated time information table.

3. The method of claim 2, wherein the calculating comprises updating the time information table so that the error time information of each of the respective input broadcast streams is included in the time information table.

4. The method of claim 1, wherein the calculating comprises generating an error time information table using the error time information of each of the respective input broadcast streams and storing the error time information table.

5. The method of claim 4 further comprising:
receiving a broadcast stream set as a new reference broadcast stream;
extracting time information from the new reference broadcast stream and setting the extracted time information as a new reference time information;
recalculating the error time information for each of the respective input broadcast streams by comparing the new reference time information with the time information of each of the respective input broadcast streams; and
updating the error time information table by reflecting results of the recalculating into the error time information.

6. The method of claim 4 further comprising:
receiving another broadcast stream which is not the reference broadcast stream;
extracting time information from the received other broadcast stream;
calculating error time information for the received other broadcast stream by comparing the reference time information with the time information extracted from the received other broadcast stream; and
updating the error time information table by reflecting the error time information for the received other broadcast stream into the error time information table.

7. The method of claim 4 further comprising:
loading time-recording time information regarding one of the input broadcast streams for which a time recording function has been set in advance;
correcting the loaded time-recording time information by referencing error time information stored in the error time information table regarding the input broadcast stream for which the time recording function has been set in advance; and
executing the time recording function so that the input broadcast stream for which the time recording function has been set in advance can be automatically recorded at a moment of time designated by the corrected time-recording time information.

8. The method of claim 1, wherein, in the setting of the reference time information, the input broadcast stream set as the reference broadcast stream is one of the input broadcast streams chosen with the aid of a user interface.

9. The method of claim 1 further comprising setting a real-time clock (RTC) of the broadcast reception device with reference to the reference time information.

10. The method of claim 1 further comprising:
loading time-recording time information regarding the broadcast stream for which the time recording function has been set;
correcting the loaded time-recording time information with reference to the error time information obtained in the calculating; and
executing the time recording function on the broadcast stream for which the time recording function has been set.

11. An apparatus for managing time information of a plurality of broadcast streams input to a broadcast reception device, the apparatus comprising:
a time information extraction unit which extracts time information from each of the respective input broadcast streams;
a reference time information setting unit which sets the time information, extracted from an input broadcast streams among the input broadcast streams that has been set in advance as a reference broadcast stream, as reference time information; and
a time error calculation unit which calculates error time information for each of the respective input broadcast streams by comparing the time information of each of the respective input broadcast stream with the reference time information.

12. The apparatus of claim 11 further comprising a storage unit which stores the time information of each of the respective input broadcast streams obtained by the reference time information setting unit and the error time information of each of the respective input broadcast streams obtained by the time error calculation unit.

13. The apparatus of claim 12, wherein the storage unit generates an error time information table using the error time information of each of the respective input broadcast streams obtained by the time error calculation unit and stores the generated error time information table.

14. The apparatus of claim 12 further comprising:
a time-recording time loading unit which loads time-recording time information regarding an input broadcast stream among the input broadcast streams for which a time recording function has been set in advance;
a time-recording time correction unit which corrects the loaded time-recording time information by referencing error time information stored in the storage unit regarding the input broadcast stream for which the time recording function has been set in advance; and
a time-recording unit which executes the time recording function so that the input broadcast stream for which the time recording function has been set in advance can be automatically recorded at a moment of time designated by the corrected time-recording time information.

15. The apparatus of claim 11 further comprising a user interface unit which enables one of the plurality of input broadcast streams to be chosen as the reference broadcast stream.

16. The apparatus of claim 11, wherein the reference time information setting unit sets a real-time clock (RTC) of the broadcast reception device with reference to the reference time information.

17. The apparatus of claim 11 further comprising a reception unit which receives the broadcast streams input to the broadcast reception device.

18. A computer-readable recording medium storing a computer program comprising:
extracting time information from each of the respective input broadcast streams;
setting the time information, extracted from an input broadcast stream among the plurality of input broadcast streams that has been set in advance as a reference broadcast stream, as reference time information; and
calculating error time information for each of the respective input broadcast streams by comparing the time information of each of the respective input broadcast streams with the reference time information.

19. A method of managing time information of a plurality of broadcast streams input to a broadcast reception device, the method comprising:
extracting time information from each of the respective input broadcast streams; and
setting the time information, extracted from an input broadcast stream among the plurality of input broadcast streams, as reference time information.
